(19) United States
(12) Patent Application Publication
(10) Pub. No.: US 2007/0140349 A1
(43) Pub. Date: Jun. 21, 2007

(54) Video encoding method and apparatus

(75) Inventor: Dzevdet Burazerovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,224

(22) PCT Filed: Feb. 24, 2005
(86) PCT No.: PCT/IB05/50673

§ 371 Date: Aug. 22, 2006

(30) Foreign Application Priority Data
Mar. 1, 2004 (EP) 04100808.7

(51) Int. Cl. H04N 11/04

(52) U.S. Cl. 375/240.18; 375/240.24

(57) ABSTRACT

A video encoder generates a plurality of reference blocks (111) and an image block of an image. An image selector (105) selects one reference block and an encoder (103, 107) codes the image block using the selected reference block. A first transform processor (113) generates transformed reference blocks by applying an associative image transform to each of the reference blocks and a second transform processor (115) generates a transformed image block by applying the associative image transform to the first image block. The video encoder (100) comprises an analysis processor (117) analyzing the image in response to data of the transformed image block. A residual processor (119) generates a plurality of residual image blocks as the difference between the transformed image block and each of the transformed reference blocks, and the appropriate reference block is selected in response. By using an associative transform, such as a Hadamard transform, transform data suitable both for image analysis and reference block selection is generated by the same operation.

The invention relates to a video encoder and method of video encoding therefor and in particular, but not exclusively, to a system of video encoding in accordance with the H.264/AVC video coding standard.

In recent years, the use of digital storage and distribution of video signals have become increasingly prevalent. In order to reduce the bandwidth required to transmit digital video signals, it is well known to use efficient digital video encoding comprising video data compression whereby the data rate of a digital video signal may be substantially reduced.

In order to ensure interoperability, video encoding standards have played a key role in facilitating the adoption of digital video in many professional—and consumer applications. Most influential standards are traditionally developed by either the International Telecommunications Union (ITU-T) or the MPEG (Motion Pictures Experts Group) committee of the ISO/IEC (the International Organization for Standardization/the International Electrotechnical Committee). The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB) standard).

Currently, one of the most widely used video compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero. For compression of chrominance data, the amount of chrominance data is usually first reduced by down-sampling, such that for each four luminance blocks, two chrominance blocks are obtained (4:2:0 format), that are similarly compressed using the DCT and quantization. Frames based only on intra-frame compression are known as Intra Frames (I-Frames).

In addition to intra-frame compression, MPEG-2 uses inter-frame compression to further reduce the data rate. Inter-frame compression includes generation of predicted frames (P-frames) based on previously decoded and reconstructed frames. In addition, MPEG-2 uses motion estimation wherein the image of macro-blocks of one frame found in subsequent frames at different positions are communicated simply by use of a motion vector. Motion estimation data generally refers to data which is employed during the process of motion estimation. Motion estimation is performed to determine the parameters for the process of motion compensation or, equivalently, inter prediction. In block-based video coding as e.g. specified by standards such as MPEG-2 and H.264, motion estimation data typically comprises candidate motion vectors, prediction block sizes (H.264), reference picture selection or, equivalently, motion estimation type (backward, forward or bi-directional) for a certain macro-block, among which a selection is made to form the motion compensation data that is actually encoded.

As a result of these compression techniques, video signals of standard TV studio broadcast quality level can be transmitted at data rates of around 2-4 Mbps.

Recently, a new ITU-T standard, known as H.26L, has emerged. H.26L is becoming broadly recognized for its superior coding efficiency in comparison to the existing standards such as MPEG-2. Although the gain of H.26L generally decreases in proportion to the picture size, the potential for its deployment in a broad range of applications is undoubted. This potential has been recognized through formation of the Joint Video Team (JVT) forum, which is responsible for finalizing H.26L as a new joint ITU-T/MPEG standard. The new standard is known as H.264 or MPEG-4 AVC (Advanced Video Coding). Furthermore, H.264-based solutions are being considered in other standardization bodies, such as the DVB and DVD Forums.

The H.264/AVC standard employs the same principles of block-based motion-compensated hybrid transform coding that are known from the established standards such as MPEG-2. The H.264/AVC syntax is, therefore, organized as the usual hierarchy of headers, such as picture-, slice- and macro-block headers, and data, such as motion-vectors, block-transform coefficients, quantizer scale, etc. However, the H.264/AVC standard separates the Video Coding Layer (VCL), which represents the content of the video data, and the Network Adaptation Layer (NAL), which formats data and provides header information.

Furthermore, H.264/AVC allows a much increased choice of encoding parameters. For example, it allows a more elaborate partitioning and manipulation of macro-blocks whereby e.g. a motion compensation process can be performed on segmentations of the 16×16 luma block of a macro-block as small as 4×4 in size. Another, and even more efficient extension, is the possibility of using variable block sizes for prediction of a macro-block. Accordingly, a macro-block (still 16×16 pixels) may be partitioned into a number of smaller blocks and each of these sub-blocks can be predicted separately. Hence, different sub-blocks can have different motion vectors and can be retrieved from different reference pictures. Also, the selection process for motion compensated prediction of a sample block may involve a number of stored, previously-decoded pictures (also known as frames), instead of only the adjacent pictures (or frames). Also, the resulting prediction error following motion compensation may be transformed and quantized based on a 4×4 block size, instead of the traditional 8×8 size.

A further enhancement introduced by H.264 is the possibility of spatial prediction within a single frame (or image). In accordance with this enhancement, it is possible to form a prediction of a block using previously-decoded samples from the same frame.

The advent of digital video standards as well as the technological progress in data and signal processing has allowed for additional functionality to be implemented in video processing and storage equipment. For example, recent years have seen significant research undertaken in the area of content analysis of video signals. Such content analysis allows for an automatic determination or estimation of the content of a video signal. The determined content may be used to provide user functionality including filtering, categorization or organization of content items. For example, the availability and variability in video content available from e.g. TV broadcasts has increased substantially in recent years, and content analysis may be used to automatically filter and organize the available content into suitable categories. Furthermore, the operation of video equipment may be altered in response to the detection of content

Content analysis may be based on video coding parameters and significant research has been directed towards algorithms for performing content analysis on the basis of in particular MPEG-2 video coding parameters and algorithms. MPEG-2 is currently the most widespread video encoding standard for consumer applications, and accordingly MPEG-2 based content analysis is likely to become widely implemented.

As a new video encoding standard, such as H.264/AVC, is rolled out, content analysis will be required or desired in many applications. Accordingly, content analysis algorithms must be developed which are suitable for the new video encoding standard. This requires significant research and development, which is time consuming and costly. The lack of suitable content analysis algorithms will therefore delay or hinder the uptake of the new video coding standard or significantly reduce the functionality that can be provided for this standard.

Furthermore, existing video systems will need to be replaced or updated in order to introduce new content analysis algorithms. This will also be costly and delay the introduction of the new video coding standard. Alternatively, additional equipment which is operable to decode the signal according to the new video coding standard followed by a re-encoding according to the MPEG-2 video coding standard must be introduced. Such equipment is complex, costly and has a high computational resource requirement.

Specifically, many content analysis algorithms are based on the use of Discrete Cosine Transform (DCT) coefficients which are obtained from intra-coded pictures. Examples of such algorithms are disclosed in J. Wang, Mohan S. Kankanhali, Philippe Mulhem, Hadi Hassan Abdulredha: “Face Detection Using DCT Coefficients in MPEG Video”, In Proc. Int. Workshop on Advanced Image Technology (IWAIT 2002), pp 60-70, Hualien, Taiwan, January 2002 and F. Snijder, P. Merlo: “Cartoon Detection Using Low-Level AV Features”, 3rd Int. Workshop on Content-Based Multimedia Indexing (CBMI 2003), Rennes, France, September 2003.

In particular, the statistics of the DC (“Direct Current”) coefficients of DCT image blocks in an image can directly indicate local properties of the brightness of the image blocks, which is used in many types of content analysis (e.g. for skin tone detection). Furthermore, since DCT coefficients for image blocks in an intra coded image are conventionally generated during encoding and decoding of the image, no additional complexity is incurred by the content analysis.

However, in coding of an Intra-frame in accordance with the H.264/AVC standard, only the difference between the image block and the predicted block is transformed by the DCT transform. The term DCT transform is intended to include the different encoding block transforms of H.264/AVC including the block transforms derived from the DCT transform. Accordingly, as the DCT in accordance with H.264/AVC is applied to the residuals of the spatial prediction rather than directly to image blocks as in previous standards, the DC coefficient indicates the average value of the prediction error rather than the luma average of the image block being predicted. Accordingly, existing content analysis algorithms based on the DC values cannot be applied directly to the DCT coefficients.

It may be possible to generate the luma averages independently and separately from the encoding process, for example by additionally performing the H.264/AVC DCT transform on the original image block. However, this requires a separate operation and will result in increased complexity and computational resource requirements.

Hence, an improved video encoding would be advantageous and in particular a video encoding allowing for facilitated and/or increased performance analysis of images and/or facilitated and/or increased performance of video encoding would be advantageous.

Accordingly, the Invention preferably seeks to mitigate, alleviate or eliminate one or more of the above mentioned disadvantages singly or in any combination.

According to a first aspect of the invention, there is provided a video encoder comprising: means for generating a first image block from an image to be encoded; means for generating a plurality of reference blocks; means for generating a transformed image block by applying an associative image transform to the first image block; means for generating a plurality of transformed reference blocks by applying the associative image transform to each of the plurality of reference blocks; means for generating a plurality of residual image blocks by determining a difference between the transformed image block and each of the plurality of transformed reference blocks; means for selecting a selected reference block of the plurality of reference blocks in response to the plurality of residual image blocks; means for encoding the first image block in response to the selected reference block; and means for performing analysis of the image in response to data of the transformed image block.

The invention may provide a convenient, easy to implement and/or low complexity way of performing an analysis of an image. In particular, generation of suitable data for the analysis may be integrated with the functionality for selecting a suitable reference block for the encoding. Accordingly, a synergistic effect between the encoding functionality and the analysis functionality is achieved. In particular, the results of generating the transformed image block by applying an associative image transform to the first image block may be used both for an analysis of the image as well as for encoding the image.

In some applications a simpler and/or more suitable implementation may be achieved. For example, if the reference blocks do not change substantially between different image blocks, the same transformed reference blocks may be used for a plurality of image blocks thereby reducing the complexity and/or required computational resource. In some applications, an improved data and/or flow structure may be achieved by first generating transformed blocks followed by generation of difference blocks rather than first generating difference blocks and subsequently performing the transformations.

In particular, the invention allows the encoding functionality, and in particular the selection of a reference block, to be in response to a transform of the image block itself rather than of a residual image block. This allows the result of the transform to retain information indicative of the image block which may be used for a suitable analysis of the image. Specifically, the transformed image block may comprise data representative of the DC coefficient of a corresponding DCT transform thereby allowing a large number of existing algorithms to use the generated data.

The residual image blocks may be determined as the difference between the individual components of the transformed image block and the individual components of each of the plurality of transformed reference blocks.

According to a feature of the invention, the associative transform is a linear transform. This provides for a suitable implementation.

According to a different feature of the invention, the associative transform is a Hadamard transform. The Hadamard transform is a particularly suitable associative transform which provides for a relatively low complexity and computational resource demanding transform while generating transform characteristics suitable for both analysis and reference block selection. Specifically, the Hadamard transform generates a suitable DC coefficient (coefficient representing an average data value of the samples of the image block) and typically also generates coefficients which are indicative of the higher frequency coefficients of a DCT transform applied to the same image block. Furthermore, the Hadamard transform is compatible with the recommendations of some advantageous encoding schemes such as H.264.

According to a different feature of the invention, the associative transform is such that a data point of a transformed image block has a predetermined relationship with an average value of data points of a corresponding non-transformed image block.

The average value of data points of an image is typically of particular interest for performing an image analysis. For example, the DC coefficient of a DCT is used in many analysis algorithms. The DC coefficient corresponds to the average value of the data points of the image block and by using a transform that generates a data point which corresponds to this value (directly or through a predetermined relationship), these analyses may be used with the associative transform.

According to a different feature of the invention, the means for performing analysis of the image is operable to perform content analysis of the image in response to data of the transformed image block.

Accordingly, the invention provides for a video encoder that facilitates combined content analysis and image encoding and which exploits a synergistic effect between these functions.

According to a different feature of the invention, the means for performing analysis of the image is operable to perform content analysis of the image in response to a DC (Direct Current) parameter of the transformed image block. The DC parameter corresponds to a parameter representing the average value of the data of the image block. This provides for a particularly suitable content analysis providing high performance.

According to a different feature of the invention, the means for generating a plurality of reference blocks is operable to generate the reference blocks in response to data values of only the image. Preferably, the video encoder is operable to encode the image as an Intra-image, i.e. by only using image data from the current image and without using motion estimation or prediction from other images (or frames). This allows for a particularly advantageous implementation.

According to a different feature of the invention, the first image block comprises luminance data. Preferably, the first image block comprises only luminance data. This provides for a particularly advantageous implementation and in particular it allows for a relatively low complexity of the analysis while providing efficient performance.

Preferably, the first image block consists in a 4 by 4 luminance data matrix. The first image block may for example also consist in a 16 by 16 luminance data matrix

According to a different feature of the invention, the means for encoding comprises determining a difference block between the first image block and the selected reference block and for transforming the difference block using a non-associative transform. This provides for improved encoding quality as for example a DCT transform may be used for encoding the image data of the image block. It may in particular provide compatibility with suitable video encoding algorithms requiring e.g. a DCT transform to be used.

Preferably, the video encoder is an H.264/AVC video encoder.

According to a second aspect of the invention, there is provided a method of video encoding, the method comprising the steps of: generating a first image block from an image to be encoded; generating a plurality of reference blocks; generating a transformed image block by applying an associative image transform to the first image block; generating a plurality of transformed reference blocks by applying the associative image transform to each of the plurality of reference blocks; generating a plurality of residual image blocks by determining a difference between the transformed image block and each of the plurality of transformed reference blocks; selecting a selected reference block of the plurality of reference blocks in response to the plurality of residual image blocks; encoding the first image block in response to the selected reference block; and performing analysis of the image in response to data of the transformed image block.

These and other aspects, features and advantages of the invention will be apparent from and elucidated with reference to the embodiment(s) described hereinafter.

An embodiment of the invention will be described, by way of example only, with reference to the drawings, in which

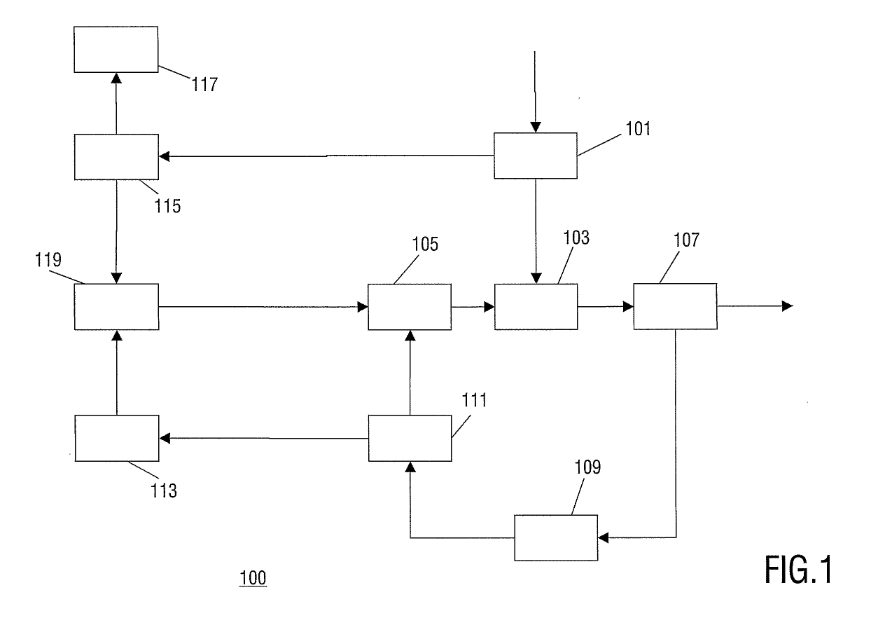

FIG. 1 is an illustration of a video encoder in accordance with an embodiment of the invention;

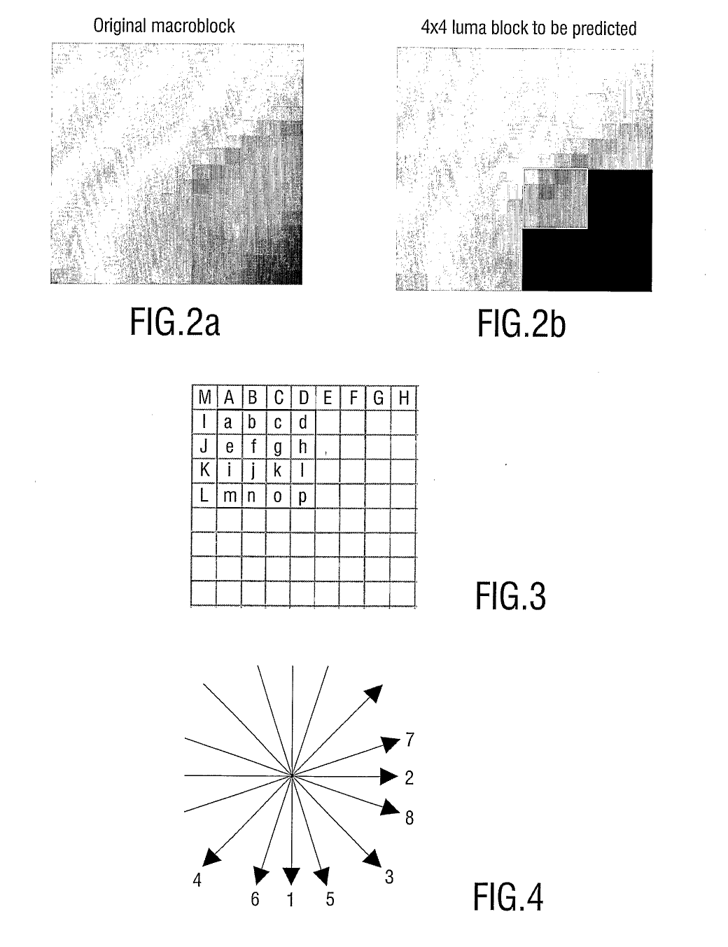

FIG. 2 is an illustration of a luma macro-block to be encoded;

FIG. 3 illustrates image samples of, and next to, a 4×4 reference block; and

FIG. 4 illustrates directions of prediction for different prediction modes of H.264/AVC.

The following description focuses on an embodiment of the invention applicable to a video encoder performing Intra-image encoding and in particular to an H.264/AVC encoder. In addition, the video encoder comprises functionality for performing content analysis. However, it will be appreciated that the invention is not limited to this application but may be applied to many other types of video encoders, video encoding operations and other analysis algorithms.

FIG. 1 is an illustration of a video encoder in accordance with an embodiment of the invention. In particular, FIG. 1 illustrates functionality for performing Intra-coding of an image (i.e. based only on image information of that image (or frame) itself). The video encoder of FIG. 1 operates in accordance with the H.264/AVC encoding standard.

Similarly to previous standards, such as MPEG-2, H.264/AVC comprises provisions for encoding an image block in intra mode, i.e. without using temporal prediction (based on the content of the adjacent images). However, in contrast to previous standards, H.264/AVC provides for spatial prediction within an image to be used for intra coding. Thus, a reference or prediction block P may be generated from previously encoded and reconstructed samples in the same picture. The reference block P is then subtracted from the actual image block prior to encoding. Accordingly, in H.264/AVC, a difference block may be generated in intra coding and the difference block rather than the actual image block is subsequently encoded by applying a DCT and quantizing operations.

For luma samples, P is formed for a 16×16 picture element macro-block or each 4×4 sub-block thereof. There are in total 9 optional prediction modes for each 4×4 block; 4 optional modes for a 16×16 macro-block, and one mode that is always applied to each 4×4 chroma block.

FIG. 2 is an illustration of a luma macro-block to be encoded. FIG. 2a illustrates the original macro-block and FIG. 2b shows a 4×4 sub-block thereof which is being encoded using a reference or prediction block generated from the image samples of already encoded picture elements. In the example, the image samples above and to the left of the sub-block have previously been encoded and reconstructed and are therefore available to the encoding process (and will be available to a decoder decoding the macro block).

FIG. 3 illustrates image samples of, and next to, a 4×4 reference block. Specifically, FIG. 3 illustrates a labeling of image samples which make up a prediction block P (a-p) and the relative location and labeling of image samples (A-M) which are used for generating the prediction block P.

FIG. 4 illustrates directions of prediction for different prediction modes of H.264/AVC. For modes 3-8, each of the prediction samples a-p is computed as a weighted average of samples A-M. For modes 0-2, all the samples a-p are given the same value, which may correspond to an average of samples A-D (mode 2), I-L (mode 1) or A-D and I-L together (mode 0). It will be appreciated that similar prediction modes exist for other image blocks such as for macro-blocks.

The encoder will typically select the prediction mode for each 4×4 block that minimizes the difference between that block and the corresponding prediction P.

Thus, a conventional H.264/AVC encoder typically generates a prediction block for each prediction mode, subtracts this from the image block to be encoded to generate difference data blocks, transforms the difference data blocks using a suitable transform and selects the prediction block resulting in the lowest values. The difference data is typically formed as the pixel-wise difference between an actual image block to be coded and the corresponding prediction block.

It should be noted that the choice of intra prediction mode for each 4×4 block must be signaled to the decoder, for which purpose H.264 defines an efficient encoding procedure.

The block transform used by the encoder may be described by:
Y=CXC^{T} (1)
where X is an N×N image block, Y contains the N×N transform coefficients and C is a pre-defined N×N transform matrix. When a transform is applied to an image block, it will yield a matrix Y of weighted values referred to as transform coefficients, indicating how much of each basis function is present in the original image.

For example, for a DCT transform, transform coefficients are generated that reflect the signal distribution at different spatial frequencies. In particular, the DCT transform generates a DC (“Direct Current”) coefficient which corresponds to a frequency of substantially zero. Thus, the DC coefficient corresponds to an average value of the image samples of the image block that the transform has been applied to. Typically, the DC coefficient has much larger value than the remaining higher spatial frequency (AC) coefficients.

Although H.264/AVC does not specify a normative procedure for selecting prediction modes, a method based on 2D Hadamard transform and Rate-Distortion (RD) optimization is recommended. According to this method, each difference image block, i.e. the difference between the original image block and a prediction block, is transformed by a Hadamard-transform, prior to being evaluated (e.g. according to a RD criterion) for selection.

In comparison to the DCT, the Hadamard transform is a much simpler and less computationally demanding transform. It furthermore results in data which is generally representative of the results achievable by a DCT. Therefore, it is possible to base the selection of the prediction block on the basis of Hadamard transforms rather than requiring a full DCT transform. Once the prediction block has been selected, the corresponding difference block may then be encoded by a DCT transform.

However, since the method applies the transform to difference data blocks rather directly to image blocks the information generated is not representative of the original image blocks but only of the prediction error. This prevents, or at least complicates, image analysis based on the transform coefficients. For example, many analysis algorithms have been developed which are based on exploiting information of transform coefficients for image blocks, and accordingly these cannot be directly applied in a conventional H.264/AVC encoder. In particular, many algorithms are based on the DC coefficient of the transform as indicative of an average property of the picture block. However, for the typical H.264/AVC approach, the DC coefficient is not representative of the original image block but only indicates the average value of the prediction error.

As an example, content analysis includes methods from image processing, pattern recognition and artificial intelligence directed to automatically determining video content based on the characteristics of the video signal. The characteristics used vary from low-level signal related properties, such as color and texture, to higher level information such as presence and location of faces. The results of content analysis are used for various applications, such as commercial detection, video preview generation, genre classification, etc.

Presently, many content analysis algorithms are based on DCT (Discrete Cosine Transform) coefficients corresponding to intra-coded pictures. In particular, the statistics of the DC (“Direct Current”) coefficients for a luma block can directly indicate local properties of the luminance of the image block and is therefore an important parameter in many types of content analysis (e.g. skin tone detection). However, in the conventional H.264/AVC encoder, this data is not available for image blocks using intra-prediction. Accordingly, these algorithms cannot be used or the information must be independently generated leading to increased complexity of the encoder.

In the current embodiment, a different approach to selection of a prediction block is proposed. An associative transform is applied directly to the image block and to the prediction blocks rather than to the difference data block. The transform coefficients of the image block may then be used directly thereby permitting the use of algorithms based on the transform coefficients of image blocks. For example, content analysis based on the DC coefficients can be applied. Furthermore, residual data blocks are generated in the transform domain by subtracting the transformed reference blocks from the transformed image block. As the transform is associative, the order of the operations is not significant and performing the subtraction after the transform rather than before the transform does not change the result. Hence, the approach provides the same performance with respect to selection of a reference block (and thus prediction mode) but in addition generates data suitable for image analysis as an integral part of the encoding process.

In more detail, the video encoder 100 of FIG. 1 comprises an image divider 101 which receives an image (or frame) of a video sequence for intra-coding (i.e. for coding as an H.264/AVC I-frame). The image divider 101 divides the image into suitable macro blocks and in the present embodiment generates a specific 4×4 luminance sample image block to be encoded. The operation of the video encoder 100 will for brevity and clarity be described with special reference to the processing of this image block.

The image divider 101 is coupled to a difference processor 103 which is also coupled to an image selector 105. The difference processor 103 receives a selected reference block from the image selector 105 and in response determines a difference block by subtracting the selected reference block from the original image block.

The difference processor 103 is furthermore coupled to an encoding unit 107 which encodes the difference block by performing a DCT transform and quantizing the coefficients in accordance with the H.264/AVC standard. The encoding element may further combine data from different image blocks and frames to generate a H.264/AVC bitstream as known to the person skilled in the art.

The encoding unit 107 is furthermore coupled to a decoding unit 109 which receives image data from the encoding unit 107 and performs a decoding of this data in accordance with the H.264/AVC standard. Thus, the decoding unit 109 generates data corresponding to the data which would be generated by a H.264/AVC decoder. In particular, when encoding a given image block the decoding unit 109 may generate decoded image data corresponding to image blocks that have already been encoded. For example, the decoding unit may generate the samples A-M of FIG. 3.

The decoding unit 109 is coupled to a reference block generator 111 which receives the decoded data. In response, the reference block generator 111 generates a plurality of possible reference blocks for use in the encoding of the current image block. Specifically, the reference block generator 111 generates one reference block for each possible prediction mode. Thus, in the specific embodiment the reference block generator 111 generates nine prediction blocks in accordance with the H.264/AVC prediction modes. The reference block generator 111 is coupled to the image selector 105 and feeds the reference blocks to this for selection.

The reference block generator 111 is furthermore coupled to a first transform processor 113 which receives the reference blocks from the reference block generator 111. The first transform processor 113 performs an associative transform on each of the reference blocks thereby generating transformed reference blocks. It will be appreciated that for some prediction modes, a fully implemented transform may not be needed. For example, for prediction modes where all sample values of the reference block are identical, a simple summation may be used to determine the DC coefficient with all other coefficients being set to zero.

In the embodiment, the associative transform is a linear transform and is particularly a Hadamard transform. The Hadamard transform is simple to implement and is furthermore associative thereby allowing subtractions between image blocks to be performed after they have been transformed rather than before the transform. This fact is exploited in the current embodiment.

Accordingly, the video encoder 100 further comprises a second transform processor 115 which is coupled to the image divider 101. The second transform processor 115 receives the image block from the image divider 101 and performs the associative transform on the image block to generate a transformed image block. Specifically, the second transform processor 115 performs a Hadamard transform on the image block.

An advantage of this approach is that the encoding process comprises a transform applied to the actual image block rather than to residual or difference image data. Accordingly the transformed image block comprises information directly related to the image data of the image block rather than to the prediction error between this and a reference block. In particular, the Hadamard generates a DC coefficient related to the average value of the samples of the image block.

Accordingly, the second transform processor 115 is further coupled to an image analysis processor 117. The image analysis processor 117 is operable to perform an image analysis using the transformed image block and is particularly operable to perform a content analysis using the DC coefficient of the DC coefficient of this and other image, blocks.

One example is detection of boundaries of shots in video. (A shot can be defined as an unbroken sequence of images taken from one camera.) The DC coefficients may be used such that the statistics of the sum of DC coefficient differences is measured along a series of successive frames. The variations in these statistics are then used to indicate potential transitions in the content, such as shot-cuts.

The result of the image analysis may be used internally in the video encoder or may for example be communicated to other units. For example, results of a content analysis may be included as meta-data in the generated H.264/AVC bitstream, for example by including the data in the auxiliary or user data sections of the H.264/AVC bitstream.

The first transform processor 113 and second transform processor 115 are both coupled to a residual processor 119 which generates a plurality of residual image blocks by determining a difference between the transformed image block and each of the plurality of transformed reference blocks. Thus, for each possible prediction mode the residual processor 119 generates a residual image block comprising information (in the transform domain) of the prediction error between the image block and the corresponding reference block.

Due to the associative nature of the applied transform, the generated residual image blocks are equivalent to the transformed difference blocks obtainable by first generating difference image blocks in the non-transformed domain and subsequently transforming these. However, in addition, the current embodiment allows the generation of data which is suitable for image analysis as an integral part of the encoding process.

The residual processor 119 is coupled to the image selector 105 which receives the determined residual image blocks. The image selector 105 accordingly selects the reference block (and thus prediction mode) used by the difference processor 103 and encoding unit 107 in the encoding of the image block. The selection criterion may for example be a Rate-Distortion criterion as recommended for H.264/AVC encoding.

Specifically, rate distortion optimization aims at effectively achieving good decoded video quality for a given target bit-rate. For example, the optimal prediction block is not necessarily the one that gives the smallest difference with the original image block, but the one that achieves a good balance between the size of the block difference and the bit-rate taking into account the encoding of the data. Specifically, each prediction of the bit-rate can by estimated by passing the corresponding residual block through the consecutive stages of the encoding process.

It will be appreciated that the above description for clarity and brevity has illustrated a particular partition of functionality but that this does not imply a corresponding hardware or software partitioning and that any suitable implementation of the functionality will be equally appropriate. For example, the entire encoding process may advantageously be implemented as firmware of a single micro-processor or digital signal processor. Furthermore, the first transform processor 113 and second transform processor 115 need not be implemented as parallel distinct elements but may be implemented by sequentially using the same functionality. For example, they may be implemented by the same dedicated hardware or by the same sub-routine.

In accordance with the described embodiment, an associative transform is used for selecting prediction modes. Thus, the transform may specifically meet the following criteria
T(I)−T(R)=T(I−R)
where T indicates the transform, I indicates the image block (matrix) and R indicates the reference block (matrix). Thus the transform is associative with respect to subtractions and additions. Preferably, the function is a linear function.

The Hadamard transform is a particularly suitable for the current embodiment. The Hadamard transform is a linear transform, and the Hadamard coefficients generally have similar characteristics as the corresponding DCT coefficients. In particular, the Hadamard transform generates a DC coefficient which represents a scaled average of samples in the underlying image block. Furthermore, based on the linearity property, the Hadamard transform of the difference of two blocks can be equivalently computed as the difference of Hadamard transforms of the two blocks.

Specifically, the associative nature of the Hadamard transform is illustrated in the following:

Let A and B be two N×N matrices, A-B the residual obtained by subtracting each element from B from a corresponding element from A, and C the N×N Hadamard matrix. By substituting these into the transform equation:
Y=CXC^{T}
the corresponding Hadamard transforms Y_{A}, Y_{B} and Y_{A-B} may be calculated. The aim is now to prove that Y_{A}-Y_{B} is identical to Y_{A-B}.

Let us for simplicity consider the case where N=2. Then, we have:

$$A = [ \begin{matrix}{a}_{11} & {a}_{12} \\ {a}_{21} & {a}_{22}\end{matrix} ] , \\ B = [ \begin{matrix}{b}_{11} & {b}_{12} \\ {b}_{21} & {b}_{22}\end{matrix} ] , \\ A - B = [ \begin{matrix}{a}_{11} - {b}_{11} & {a}_{12} - {b}_{12} \\ {a}_{21} - {b}_{21} & {a}_{22} - {b}_{22}\end{matrix} ] and$$

$$C = [ \begin{matrix}1 & 1 \\ 1 & - 1\end{matrix} ]$$

$$This yields \text{:}$$

$$\begin{matrix}{Y}_{A} = {CAC}^{T} \\ = [ \begin{matrix}1 & 1 \\ 1 & - 1\end{matrix} ] [ \begin{matrix}{a}_{11} & {a}_{12} \\ {a}_{21} & {a}_{22}\end{matrix} ] [ \begin{matrix}1 & 1 \\ 1 & - 1\end{matrix} ] \\ = [ \begin{matrix}{a}_{11} + {a}_{21} + {a}_{12} + {a}_{22} & {a}_{11} + {a}_{21} - {a}_{12} - {a}_{22} \\ {a}_{11} - {a}_{21} + {a}_{12} - {a}_{22} & {a}_{11} - {a}_{21} - {a}_{12} + {a}_{22}\end{matrix} ]\end{matrix}$$

$$\begin{matrix}{Y}_{B} = {CBC}^{T} \\ = [ \begin{matrix}1 & 1 \\ 1 & - 1\end{matrix} ] [ \begin{matrix}{b}_{11} & {b}_{12} \\ {b}_{21} & {b}_{22}\end{matrix} ] [ \begin{matrix}1 & 1 \\ 1 & - 1\end{matrix} ] \\ = [ \begin{matrix}{b}_{11} + {b}_{21} + {b}_{12} + {b}_{22} & {b}_{11} + {b}_{21} - {b}_{12} - {b}_{22} \\ {b}_{11} - {a}_{21} + {b}_{12} - {b}_{22} & {b}_{11} - {b}_{21} - {b}_{12} + {b}_{22}\end{matrix} ]\end{matrix}$$

$$\begin{matrix}{Y}_{A - B} = C ( A - B ) {C}^{T} \\ = [ \begin{matrix}1 & 1 \\ 1 & - 1\end{matrix} ] \\ = [ \begin{matrix}{a}_{11} - {b}_{11} & {a}_{12} - {b}_{12} \\ {a}_{21} - {b}_{21} & {a}_{22} - {b}_{22}\end{matrix} ] [ \begin{matrix}1 & 1 \\ 1 & - 1\end{matrix} ] \\ = … \\ = {Y}_{A} - {Y}_{B}\end{matrix}$$

Thus, in the specific embodiment, the application of the Hadamard transform to each luma block and to each of the corresponding prediction (reference) blocks achieves that the same operations generate parameters suitable for both content analysis and for selecting a prediction mode for the encoding.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A video encoder comprising:
means for generating a first image block (101) from an image to be encoded;
means for generating a plurality of reference blocks (111);
means for generating a transformed image block (115) by applying an associative image transform to the first image block;
means for generating a plurality of transformed reference blocks (113) by applying the associative image transform to each of the plurality of reference blocks;
means for generating a plurality of residual image blocks (119) by determining a difference between the transformed image block and each of the plurality of transformed reference blocks;
means for selecting a selected reference block (105) of the plurality of reference blocks in response to the plurality of residual image blocks;
means for encoding (103, 107) the first image block in response to the selected reference block; and
means for performing analysis (117) of the image in response to data of the transformed image block.

2. A video encoder as claimed in claim 1 wherein the associative transform is a linear transform.

3. A video encoder as claimed in claim 1 wherein the associative transform is a Hadamard transform.

4. A video encoder as claimed in claim 1 wherein the associative transform is such that a data point of a transformed image block has a predetermined relationship with an average value of data points of a corresponding non-transformed image block.

5. A video encoder as claimed in claim 1 wherein the means for performing analysis of the image (117) is operable to perform content analysis of the image in response to data of the transformed image block.

6. A video encoder as claimed in claim 5 wherein the means for performing analysis of the image (117) is operable to perform content analysis of the image in response to a DC (Direct Current) parameter of the transformed image block.

7. A video encoder as claimed in claim 1 wherein the means for generating a plurality of reference blocks (111) is operable to generate the reference blocks in response to data values of only the image.

8. A video encoder as claimed in claim 1 wherein the first image block comprises luminance data.

9. A video encoder as claimed in claim 1 wherein the first image block consists in a 4 by 4 luminance data matrix.

10. A video encoder as claimed in claim 1 wherein the means for encoding (103, 107) comprises determining a difference block (103) between the first image block and the selected reference block and means for transforming the difference block (107) using a non-associative transform.

11. A video encoder as claimed in claim 1 wherein the video encoder is an H.264/AVC video encoder.

12. A method of video encoding comprising the steps of:
generating a first image block from an image to be encoded;
generating a plurality of reference blocks;
generating a transformed image block by applying an associative image transform to the first image block;
generating a plurality of transformed reference blocks by applying the associative image transform to each of the plurality of reference blocks;
generating a plurality of residual image blocks by determining a difference between the transformed image block and each of the plurality of transformed reference blocks;
selecting a selected reference block of the plurality of reference blocks in response to the plurality of residual image blocks;
encoding the first image block in response to the selected reference block; and
performing analysis of the image in response to data of the transformed image block.

13. A computer program enabling the carrying out of a method according to claim 12.

14. A record carrier comprising a computer program as claimed in claim 13.
